(19) United States
(12) Patent Application Publication
(10) Pub. No.: US 2026/0037165 A1
(43) Pub. Date: Feb. 5, 2026

(54) SELECTIVE WRITE IN A MEMORY SYSTEM

(71) Applicant: Micron Technology, Inc., Boise, ID (US)

(72) Inventors: Graziano Mirichigni, Vimercate (CA); Marco Sforzin, Cernusco Sul Naviglio MI (IT); Antonino Capri', Bergamo (IT)

(21) Appl. No.: 19/286,824

(22) Filed: Jul. 31, 2025

Related U.S. Application Data
(60) Provisional application No. 63/677,657, filed on Jul. 31, 2024.

(51) Int. Cl. G06F 3/06

(52) U.S. Cl. CPC G06F 3/0626; G06F 3/0659; G06F 3/0679

(57) ABSTRACT

Selective writing in memory modules can help optimize system resources. In an example, Data Mask Inversion (DMI) signals can be used to selectively mask write operations on specific devices. In an example, a write command-based solution uses a selective write command, enabling granular control over which portions of a burst length are written to each of multiple devices. The systems and methods discussed herein can enable more efficient use of memory bandwidth and precise control over data placement in multi-device memory systems, thereby improving overall system performance and flexibility.

### PRIORITY APPLICATION

This application claims the benefit of priority to U.S. Provisional Application Ser. No. 63/677,657, filed Jul. 31, 2024, which is incorporated herein by reference in its entirety.

### TECHNICAL FIELD

The present disclosure relates generally to semiconductor memory and methods, and more particularly, to apparatuses, systems, and methods for performing selective writes in a memory system.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), synchronous dynamic random access memory (SDRAM), and thyristor random access memory (TRAM), among others. Non-volatile memory can provide persistent data by retaining stored data when not powered and can include NAND flash memory, NOR flash memory, ferroelectric random access memory (FeRAM), and resistance variable memory such as phase change random access memory (PCRAM), resistive random access memory (RRAM), and magnetoresistive random access memory (MRAM), such as spin torque transfer random access memory (STT RAM), among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system. A controller may be used to manage the transfer of data, commands, and/or instructions between the host and the memory devices.

### BRIEF DESCRIPTION OF THE DRAWINGS

The present disclosure will be understood more fully from the detailed description given below and from the accompanying drawings of various embodiments of the disclosure.

FIG. 1 illustrates a block diagram of a computing system including a controller for selective writes in a memory device in accordance with a number of embodiments of the present disclosure.

FIG. 2 illustrates a block diagram of a controller for selective write in a memory device in accordance with a number of embodiments of the present disclosure.

FIG. 3 is an example of a number of memory devices for performing a plurality of write operations in accordance with some embodiments of the present disclosure.

FIGS. 4A-4B are each an example of a signal diagram for a number of write operations being performed on a number of memory devices using a data mask inversion (DMI) based approach in accordance with some embodiments of the present disclosure.

FIGS. 5A-5B each illustrate an example of a mode register for performing a selective write in accordance with some embodiments of the present disclosure.

FIG. 6 is an example of a memory system including a number of memory devices and corresponding HIGH or LOW signals associated with performing a selective write operation at different stages in accordance with some embodiments of the present disclosure.

FIGS. 7A-7B are each an example of a signal diagram for a number of write operations being performed on a number of memory devices using a write-based approach in accordance with some embodiments of the present disclosure.

FIG. 8 is an example of a first method for performing selective writes in a memory device in accordance with embodiments of the present disclosure.

FIG. 9 is an example of a second method for performing selective writes in a memory device in accordance with embodiments of the present disclosure.

FIG. 10 is an example of a third method for performing selective writes in a memory device in accordance with embodiments of the present disclosure.

### DETAILED DESCRIPTION

Aspects of the present disclosure are directed to performing selective writes using a memory system, such as writing a portion of a burst length to one or more components of the memory system. The portion of the burst length can be written to one or more components of the memory system by masking writes to at least some of the one or more components also present on the memory channel. A memory system can comprise, for example, a storage system, storage device, a memory module, or a combination thereof Δn example of a memory system is a storage system such as a solid-state drive (SSD). In general, a host system can use a memory system that includes one or more components, such as memory devices that store data. The host system can provide data to be stored at the memory system and can request data to be retrieved from the memory system.

Systems, apparatuses, and methods related to selected writes in a memory system are described herein. An example method can include receiving, at a memory controller and from a host, a command to write a portion of a burst length of data to one of a plurality of memory devices. In an example, the memory controller can manage a non-volatile memory device or a volatile memory device. In an example, a compute express link (CXL) protocol is used to communicate between a host and a memory device (e.g., a DRAM device). The command can be executed to write a portion of the burst length of data to a memory device while masking another portion of the burst length of data. In an example, the method can include masking a portion of the burst length of data with respect to one memory device, while a remaining portion of the burst length of data can be written to one or more other memory devices.

A controller for selective writes can include a front end portion, a central controller portion (sometimes referred to as a “central controller”), and a back end portion. The central controller can include a security component and can be configured to cause performance of memory operations for performing the selective write operations. The controller (herein sometimes referred to as a memory controller) can include a variety of components to manage each of one or multiple types of memory devices that can be coupled to the memory controller. In some embodiments, the memory controller can enable or disable certain components depending on whether the components are used to transfer the data from the host to one of the memory devices or are masked in order to prevent transferring data to the components. For example, a command sent from the host can indicate which portion of a plurality of memory devices to write to and which portion of the plurality of memory devices to mask and not write to. The writing and masking data can be stored in a register that can be accessed by the memory controller to determine whether to write or mask a portion of the plurality of memory devices and to determine which portion of data to write to a particular memory device of the plurality of memory devices.

In some previous approaches, data can be transferred in parallel to each of the plurality of memory devices without a method to mask or prevent one or more of the plurality of memory devices from being written to. As an example, an entire burst length of data may have been written to each of the plurality of memory devices in parallel without a mechanism to not write data to the other portions of the burst length of data. In contrast, embodiments described herein are directed to performing selective writes on at least one of the plurality of memory devices. In an example, a write operation can be selective in terms of which memory device is written to and/or in terms of which portion of a burst length of data is allowed to be written to one or more memory devices. The selective writing can be performed using a data mask inversion-based (DMI-based) approach, a write-based approach, and/or one or more other approaches that can indicate which portion of the burst length to write and which portion of the burst length to mask and not write.

In some embodiments, the memory system can be a Compute Express Link (CXL) compliant memory system (e.g., the memory system can include a PCie/CXL interface). CXL is a high-speed central processing unit (CPU)-to-device and CPU-to-memory interconnect designed to accelerate next-generation performance. CXL technology maintains memory coherency between the CPU memory space (of a host) and memory on attached devices, which allows resource sharing for higher performance, reduced software stack complexity, and lower overall system cost.

CXL is designed to be an industry open standard interface for high-speed communications, as accelerators are increasingly used to complement CPUs in support of emerging applications such as artificial intelligence and machine learning. CXL technology is built on the peripheral component interconnect express (PCie) infrastructure, leveraging PCie physical and electrical interfaces to provide advanced protocols in areas such as input/output (I/O), memory transactions (e.g., initially allowing a host to share memory with an accelerator), and coherency. The selective write approaches described herein are configured to be compatible with and easily integrated into existing JEDEC (e.g., DDR5) standard specifications. Both the DMI-based and write command-based selective write solutions discussed herein can use existing infrastructure and signaling protocols used by DDR5 memory devices and controllers. The DMI-based approach can use new data mask inversion signals, while the write command-based approach extends the existing JEDEC command structure through the addition of a selective write bit (SWB) that can be mapped to available command/address pins. The mode register configurations for selective write functionality can be implemented using reserved-for-future-use (RFU) bits in existing DDR5 mode registers, thereby maintaining backward compatibility. This standards-compliant design helps enable selective write capabilities without modifications to existing physical interfaces, timing specifications, or electrical characteristics.

In the following detailed description of the present disclosure, reference is made to the accompanying drawings that show, by way of illustration, how one or more embodiments of the disclosure may be practiced. These embodiments are described in sufficient detail to enable those of ordinary skill in the art to practice the embodiments of this disclosure, and it is to be understood that other embodiments may be used and that process, electrical, and structural changes may be made without departing from the scope of the present disclosure.

It is also to be understood that the terminology used herein is for the purpose of describing particular embodiments only, and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory banks) can refer to one or more, whereas a “plurality of” is intended to refer to more than one of such things.

Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled” and “coupling” mean to be directly or indirectly connected physically or for access to and movement (transmission) of commands and/or data, as appropriate to the context. The terms “data” and “data values” are used interchangeably herein and can have the same meaning, as appropriate to the context.

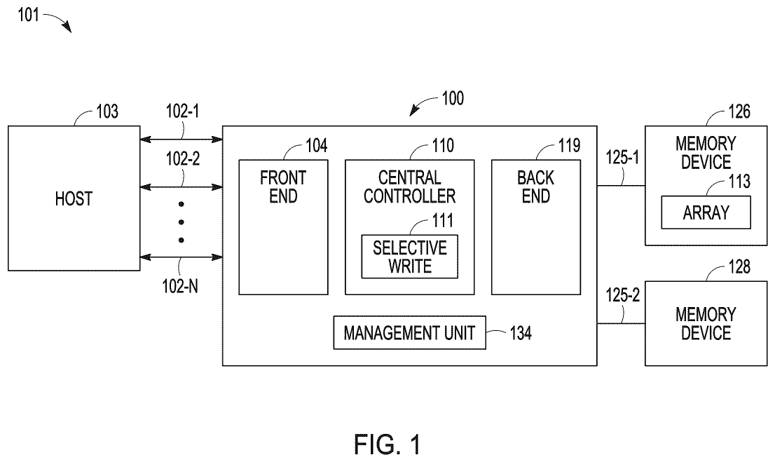

FIG. 1 illustrates a block diagram in the form of a computing system 101 including a memory controller 100 for selective write operations in memory (e.g., memory devices 126, 128) in accordance with a number of embodiments of the present disclosure. As an example, the memory controller 100 can be used to read from and/or write data to a memory device. In an example, the memory controller 100 includes a front end portion 104, a central controller portion 110, and a back end portion 119. The central controller portion 110 can include a selective write component 111. Examples of the selective write component 111 can include, but are not limited to, hardware, software and/or circuitry configured to select portions of data to write to particular or selected portions of memory. In an example, the computing system 101 can be coupled to a host 103 and memory devices 126, 128. The memory device 126 can include an array 113 of memory cells where the data is stored. The array 113 can include registers, such as mode registers that will be described further herein, that are used to store data associated with selecting portions of the memory devices to be written to and portions of the memory devices to be masked and not written to. In some embodiments, the memory device 126 is a DRAM memory device and/or the memory device 128 may be a same type of memory device (e.g., DRAM memory device) or a different type of memory device.

The front end portion 104 can include a flexible bus interconnect and can be configured to use CXL protocol layers including CXL.io and CXL.mem. The front end portion 104 includes an interface to couple the memory controller 100 to the host 103 through input/output (I/O) lanes 102-1, 102-2, . . . , 102-N (individually or collectively referred to as I/O lanes 102) and circuitry to manage the I/O lanes 102. In some embodiments, there can be eight (8) I/O lanes 102 and in other embodiments there can be sixteen (16) I/O lanes 102. In some embodiments, the plurality of I/O lanes 102 can be configured as a single port.

The memory controller 100 can include a central controller portion 110 that can control, in response to receiving a request from the host 103, performance of a memory operation. The memory operation can be a memory operation to read data from a memory device 126, 128 or an operation to write data to a memory device 126, 128. In some embodiments, the central controller portion 110 can, in response to receiving a request from the host 103, control writing of multiple pages of data substantially simultaneously.

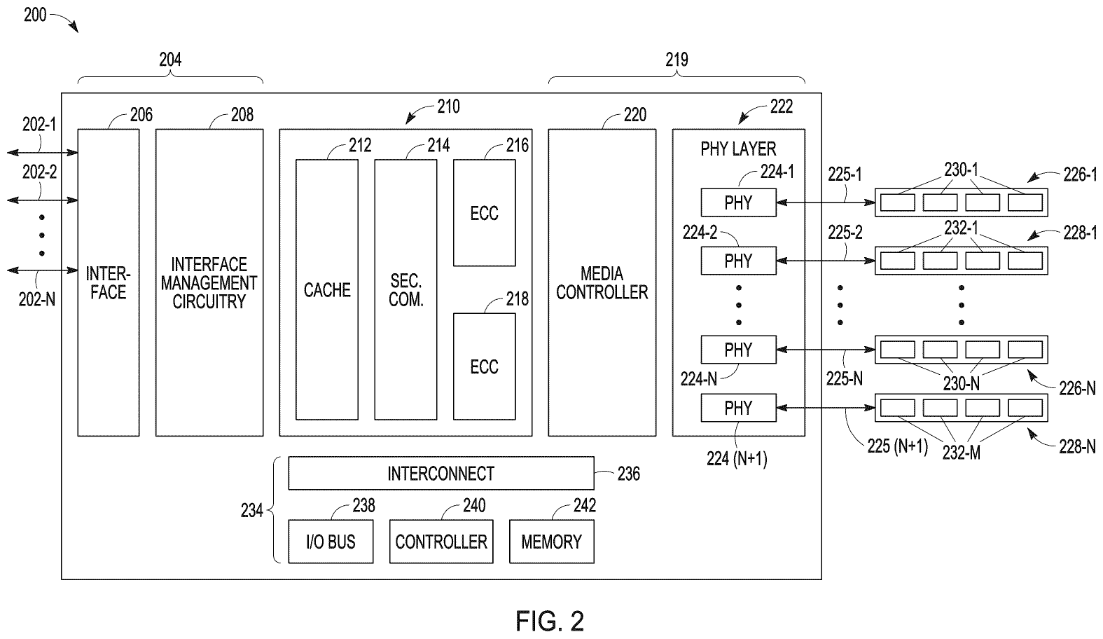

The central controller portion 110 can include a cache (e.g., the cache 212 illustrated in FIG. 2, herein) to store data associated with performance of a memory operation and/or a selective write component 111 to determine which portions of a burst length of data to write to which memory devices, as described further below. In some embodiments, in response to receiving a request from the host 103, data from the host 103 can be stored in cache lines of the cache. The data in the cache can be written to a memory device 126, 128. In some embodiments, the selective write component 111 includes or uses write selection data to determine portions of the burst length of data to write to respective memory devices. The write selection data can be stored in the cache 212, such as additionally or alternatively to being stored in the array 113. In some embodiments, the data can be transferred from the cache 212 in order to be encrypted using an Advanced Encryption Standard (AES) before being written to a memory device 126, 128. In some embodiments, the data can be encrypted using Advanced Encryption Standard (AES) encryption before the data is stored in the cache. However, embodiments are not so limited, as, for example, the data can be encrypted after being read from the cache.

The central controller portion 110 can include error correction code (ECC) encoding circuitry (e.g., the ECC encoding circuitry 216 illustrated in FIG. 2, herein) to ECC encode the data, and can include ECC decoding circuitry (e.g., the ECC decoding circuitry 218 illustrated in FIG. 2, herein) to ECC decode the data. As used herein, the term “ECC encoding” can refer to encoding data by adding redundant bits to the data. As used herein, the term “ECC decoding” can refer to examining the ECC encoded data to check for any errors in the data. The ECC encoding circuitry can encode data that will be written to the memory devices 126, 128. In some embodiments, an error detected in the data can be corrected immediately upon detection. The ECC decoding circuitry can decode data that has been previously ECC encoded.

In some embodiments, the memory controller 100 can comprise a back end portion 119 comprising a media controller and a physical (PHY) layer that couples the memory controller 100 to a plurality of memory ranks. As used herein, the term “PHY layer” generally refers to the physical layer in the Open Systems Interconnection (OSI) model of a computing system. The PHY layer may be the first (e.g., lowest) layer of the OSI model and can be used to transfer data over a physical data transmission medium. In some embodiments, the physical data transmission medium can be a plurality of channels 125-1, 125-2. As used herein, the term “memory ranks” generally refers to a plurality of memory chips (e.g., DRAM memory chips and/or other type of memory chips) that can be accessed simultaneously. In some examples, a memory rank can be sixty four (64) bits wide and each memory rank can have eight (8) pages. In some embodiments, a page size of a first type of memory device (e.g., a DRAM memory device) 126 can be larger than a page size of the second type of memory device (e.g., a volatile or non-volatile memory device) 128. However, embodiments are not so limited to these parameters.

In some embodiments, the memory controller 100 can include a management unit 134 to initialize, configure, and/or monitor characteristics of the memory controller 100. For example, the management unit 134 can be used to execute functions such as logging, error reporting, support of discovery by the host, security protocols management, security functions, etc.

The management unit 134, in some examples, can include two sub-systems: an open system including a central processing unit (CPU) for a main firmware and related resources and a secure system including a CPU for secure firmware and related resources (including cryptographic engines such as AES, SHA, RSA (Rivest-Shamir-Adleman), etc.). The management unit 134 can include an I/O bus to manage out-of-band data and/or commands, a management unit controller to execute one or more instructions associated with initializing, configuring, and/or monitoring the characteristics of the memory controller, and a management unit memory to store data associated with initializing, configuring, and/or monitoring the characteristics of the memory controller 100. As used herein, the term “out-of-band data and/or commands” generally refers to data and/or commands transferred through a transmission medium that is different from the main transmission medium of a network. For example, out-of-band data and/or commands can be data and/or commands transferred to a network using a different transmission medium than the transmission medium used to transfer data within the network.

FIG. 2 illustrates a block diagram in the form of a memory controller 200 for performing selective write operations in a memory device in accordance with a number of embodiments of the present disclosure. A memory controller 200 is configured to manage a first type of memory device (e.g., DRAM memory device) 226-1, . . . , 226-N (individually or collectively referred to as the first type of memory device 226) that operates according to a first set of timing characteristics and a second type of memory device 228-1, . . . , 228-N (individually or collectively referred to as the second type of memory device 228) that operates according to a second set of timing characteristics. Further, in some embodiments, instead of managing both a DRAM memory device 226 and an additional memory device 228, the memory controller 200 can be configured to manage either just memory devices 226 or just the additional memory devices 228. In some embodiments, a memory controller 200 can include a front end portion 204, a central controller portion 210, and a back end portion 219.

As shown in FIG. 2, a front end portion 204 can include an interface 206 that includes multiple I/O lanes 202-1, 202-2, . . . , 202-N (individually or collectively referred to as I/O lanes 202), as well as interface management circuitry 208 to manage the interface 206. The interface 206 can be a peripheral component interconnect express (PCie) 5.0 interface coupled to the I/O lanes 202. In some embodiments, the memory controller 200 can receive access requests involving at least one of the cache 212, the first type of memory device 226, and/or the second type of memory device 228 via the PCie 5.0 interface 206 according to a CXL protocol. The interface 206 can receive data from a host (e.g., the host 103 shown in FIG. 1) through the I/O lanes 202. The interface management circuitry 208 may use CXL protocols to manage the interface 206.

A central controller portion 210 can be configured to cause performance of a memory operation and/or a security operation, as described below. The central controller portion 210 can include a cache 212 to store data associated with performance of the memory operation. In some non-limiting examples, the cache 212 can be a thirty two (32) way set-associative cache including multiple cache lines. The cache line size can be equal to the memory controller 200 read granularity.

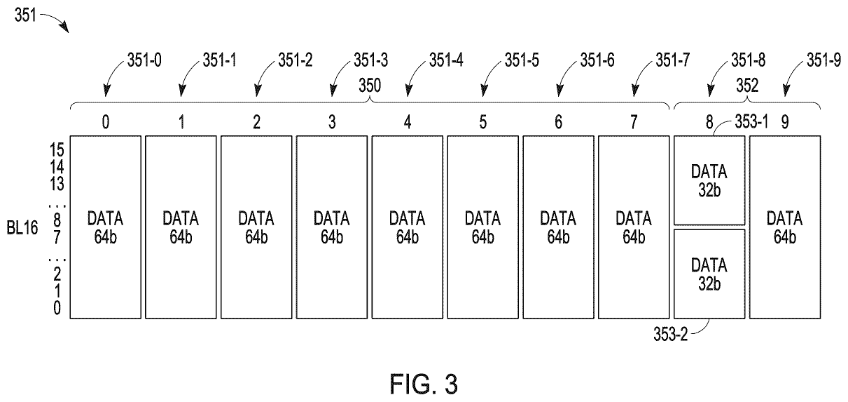

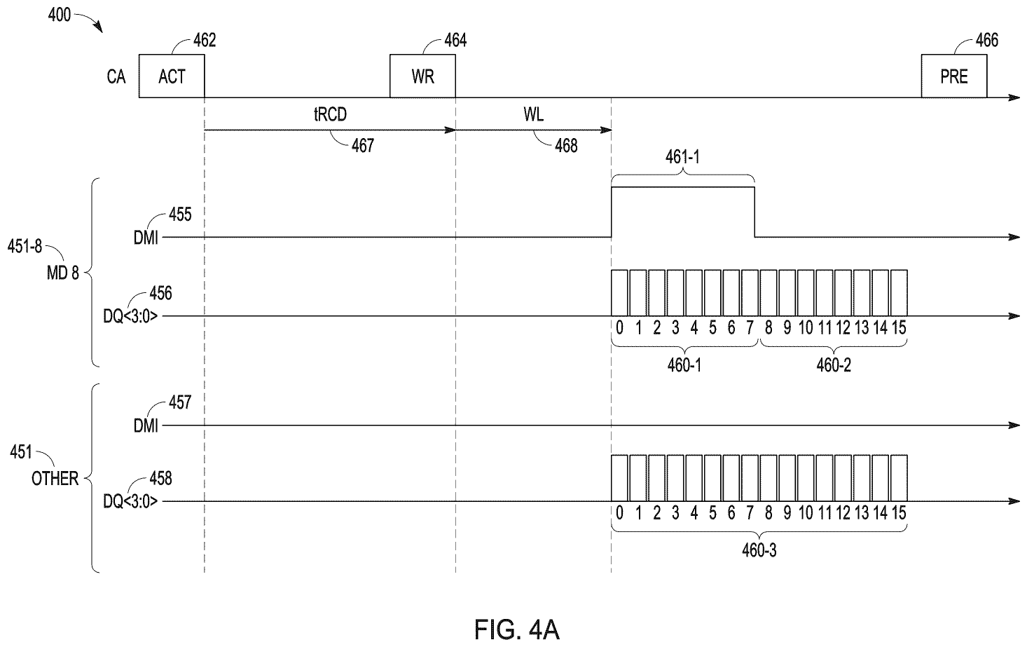

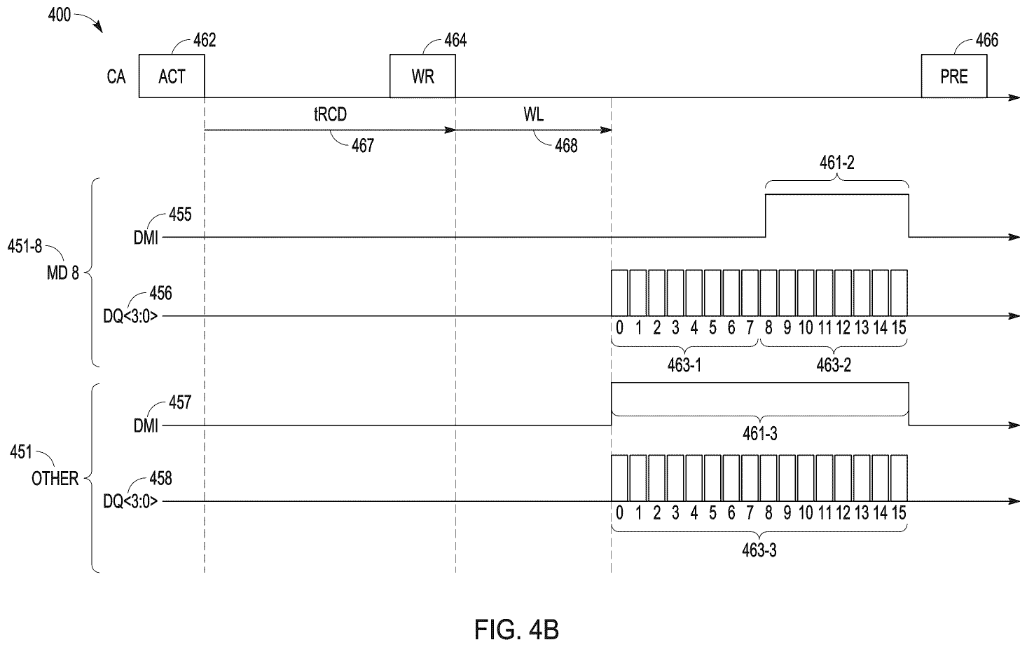

Read and write requests of CXL memory systems can be 64 bytes in size, as will be illustrated and described in more detail in association with FIG. 3 below. Therefore, in some non-limiting examples, data entries in the cache 212 can have 64 bytes of data. Each cache line can comprise, as an example, 256 bytes, or some other amount of data. Therefore, multiple 64 byte requests can be stored in each cache line. In response to a request from the host, the memory controller 200 can write 256 bytes of data to a memory device 226, 228. In some embodiments, the 256 bytes of data can be written in 64 byte chunks. In some embodiments, the 64 byte chunks can be written with additional data, such as parity data or other supporting data. Transferring data in response to read and write requests can include using a burst length of data. The burst length of the data refers to the number of consecutive data elements that can be transferred in a single burst or block of data during a read or write operation. The burst length can be selected based on a balancing of trade-offs between data throughput and latency. The burst length of the subsequent examples will be described in association with FIGS. 4A-4B below. The approach described herein is used to select a portion of a burst length for writing data to the memory devices 126, 128 while not writing data of the other portions of the burst length. In this way, smaller portions of data can be targeted for writing the data without writing the entire burst length of the data.

As shown in FIG. 2, the memory controller 200 can include a back end portion 219, including a media controller 220 comprising a plurality of media controllers and a physical (PHY) layer portion 222 comprising a plurality of PHY layers 224-1, 224-2, 224-N, . . . , 224-(N+1) (individually or collectively referred to as PHY layer 224). In some embodiments, the back end portion 219 is configured to couple the PHY layer portion 222 to a plurality of memory ranks 230-1, . . . , 230-N (individually or collectively referred to as memory ranks 230) of a first memory device 226 and a plurality of memory ranks 232-1, . . . , 232-M (individually or collectively referred to as memory ranks 232) of a second memory device 228-1, . . . , 228-N (individually or collectively referred to as second memory device 228). The media controller 220 can operate following both open-page policies and a closed-page policies. As used herein, the term “open-page policy” generally refers to a policy which allows a memory controller (e.g., media controller 220) to leave a page of memory open for a certain amount of time after a read operation or a write operation is performed. As used herein, the term “closed-page policy” generally refers to a policy that ensures that a page of memory is closed immediately after a read operation or a write operation is performed. In some embodiments, as a non-limiting example, the additional memory device 228 can implement a closed-page policy with an additional requirement that the tRAS of the additional memory device 228 is less than five hundred (500) ns.

In some embodiments, the media controller 220 can be configured to use a RAS (Reliability, Availability, and Serviceability) scheme to detect and correct errors in memory, such as using error correcting code (ECC) mechanisms. In an example, mechanisms such as Low-power Chip-Kill (LPCK) or other chipkill solutions based on Reed-Solomon (RS) codes can be used. Other techniques can similarly be used.

In an example, the media controller 220 can be a single media controller. When implementing error correction, a plurality of channels 225-1, 225-2, 225-N, . . . , 225-(N+1) (individually or collectively referred to as the plurality of channels 225) can be driven concurrently to write data to the memory device 226 and/or the additional memory device 228. In some embodiments, instead of using a single media controller 220, multiple media controllers can be used to drive the plurality of channels 225. When multiple media controllers are used to drive the channels 225 concurrently, the media controllers are utilized substantially simultaneously.

As used herein, the term “substantially” intends that the characteristic need not be absolute, but is close enough so as to achieve the advantages of the characteristic. For example, “substantially simultaneously” is not limited to operations that are performed absolutely simultaneously and can include timings that are intended to be simultaneous but due to manufacturing limitations may not be precisely simultaneously. For example, due to read/write delays that may be exhibited by various interfaces (e.g., LPDDR5 vs. PCie), media controllers that are utilized “substantially simultaneously” may not start or finish at exactly the same time. For example, the multiple memory controllers can be used such that they are writing data to the memory devices at the same time regardless of whether one of the media controllers commences or terminates prior to the other.

In an example, each of the plurality of media controllers can receive a same command and address and drive the plurality of channels 225 substantially simultaneously. By using the same command and address for the plurality of media controllers, each of the plurality of media controllers can use the plurality of channels 225 to perform the same memory operation on the same plurality memory cells.

A back end portion 219 can include multiple PHY layers 224 and the media controller 220 that is configured to drive the channels 225 that couple PHY layers 224 to the memory ranks 230, 232. In some embodiments, as a non-limiting example, the memory controller 200 can be coupled to the memory ranks 230, 232 through channels 225 coupled to the back end portion 219 and each of the plurality of channels 225 is coupled to four (4) memory ranks 230, 232.

The memory controller 200 can include a management unit 234 configured to initialize, configure, and/or monitor characteristics of the memory controller 200. Further, the management unit 234 can be used to execute functions such as logging, error reporting, support of discovery by the host, security protocol management, security functions, etc. In some embodiments, the management unit 234 includes an I/O bus 238 configured to manage out-of-band data and/or commands, a management unit controller 240 to execute instructions associated with initializing, configuring, and/or monitoring the characteristics of the memory controller 200, and a management unit memory 242 to store codes and/or data associated with managing and/or monitoring the characteristics of the memory controller 200. An endpoint of the management unit 234 can be exposed to the host system (e.g., the host 103 shown in FIG. 1) to manage data. In some embodiments, the characteristics monitored by the management unit 234 can include a voltage supplied to the memory controller 200 or a temperature measured by external sensors, or both. Further, the management unit 234 can include an advanced high-performance bus (AHB) interconnect 236 to couple different components of the management unit 234. However, embodiments are not so limited and the management unit 234 can include other interconnects to couple the different components of the management unit 234.

The I/O bus 238 can be configured to transfer out-of-band data and/or commands. In some embodiments, the I/O bus 238 can be a System Management Bus (SMBus). As used herein, the term “SMBus” generally refers to a single-ended simple two-wire bus for the purpose of lightweight communication. In an example, the management unit 234 can include circuitry to manage in-band data. As used herein, the term “in-band signaling” generally refers to a method for signaling events and conditions using the Link between two components, as opposed to the use of separate physical (sideband) signals. Mechanisms defined herein can be implemented using in-band signaling, although in some form factors sideband signaling may be used, in the alternative.

The management unit 234 can include a management unit controller 240. In some embodiments, the management unit controller 240 can be a microcontroller that meets the Joint Test Action Group (JTAG) standard and is capable, among other things, to run according to an Inter-Integrate Circuit (12C or 13C) protocol, and auxiliary I/O circuitry. As used herein, the term “JTAG” generally refers to an industry standard for verifying designs and testing printed circuitry boards after manufacture. As used herein, the term “I2C” generally refers to a serial protocol for a two-wire interface to connect low-speed devices like microcontrollers, I/O interfaces, and other similar peripherals in embedded systems. In some embodiments, the auxiliary I/O circuitry can couple the management unit 234 to the memory controller 200. Further, firmware for operating the management unit can be stored in the management unit memory 242. In some embodiments, the management unit memory 242 can be a flash memory such as flash NOR memory or other persistent flash memory device.

FIG. 3 is an example of multiple memory devices for performing a plurality of write operations in accordance with some embodiments of the present disclosure. The number of memory devices 351 can include a zeroth (0^{th}) memory device 351-0 through ninth (9^{th}) memory device 351-9 (hereinafter referred to collectively as memory devices 351), totaling ten memory devices in this example. As used herein, a memory die and a memory device can be used interchangeably to describe the element to which the selective write pertains. The 0^{th} memory device 351-0 through the 7^{th} memory device 351-7 can be used to store data used for memory operations while the 8^{th} memory device 351-8 and 9^{th} memory device 351-9 can be used to store associated parity data or other data used to protect or maintain the data. In an example that uses a 16 beat burst length, each of the memory devices 351 can transmit 64 bits, or 8 bytes, per burst. A beat can refer to a single data transfer cycle during a burst operation. In a BL16 (burst length 16) operation, there are 16 beats numbered 0 through 15, as illustrated in FIG. 3.

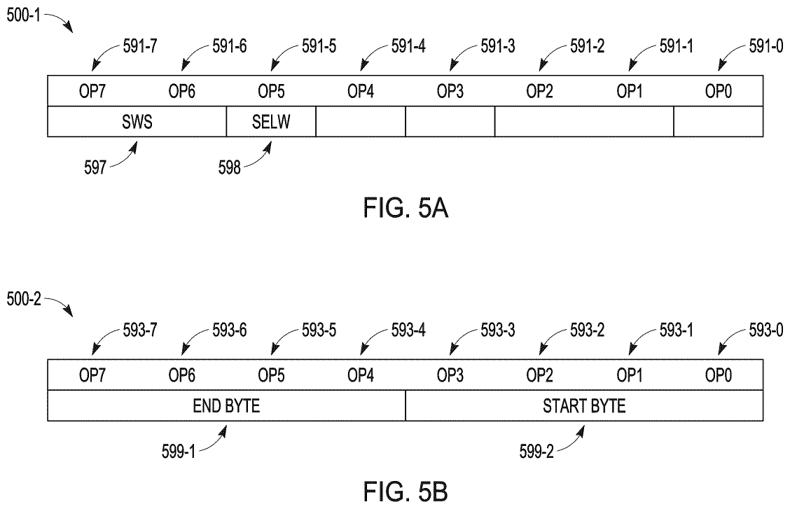

A single read or write access frame can use different burst lengths to write data to a memory device. In the example of FIG. 3, a burst length of 16 is used for each of the memory devices 351. In this example, the data can be transferred using a data width where each memory device has 4 data lines or data bits (e.g., an “×4 DQ”). The data width specifies how many bits of data the memory device can read or write simultaneously per data transfer. “DQ” stands for a data queue or data pin. These are physical pins on the memory chip that handle data input and output. In the context of “×4 DQ,” there are 4 data pins used for each data transfer. The data can be written to the memory devices 351 in parallel. In this way, each burst of data includes writing 4 bits to each of the memory devices 351 in parallel. Likewise, two bursts of data equals a byte of data, and sixteen bursts of data equals 64 bits or 8 bytes of data, which is the capacity of writing a full burst length to each of the memory devices 351, as shown in FIG. 3. The 8^{th} memory device 351-8 is illustrated as split into two portions of 32 bits, or 4 bytes in each of a first portion of data 353-1 and a second portion of data 353-2. This is illustrated for the purpose of showing that the first 8 bursts of data associated with writing the first portion of data 353-1 of the burst length can be written while the second 8 bursts of data associated with the second portion of data 353-2 can be masked and not written. In addition, while the first portion of data 353-1 is written, the other memory devices 351-0, 351-1, 351-2, 351-3, 351-4, 351-5, 351-6, 351-7, and 351-9 can be masked and not written, as will be described further below in association with FIGS. 4A-5B.

FIGS. 4A-4B are each an example of a signal diagram for a number of write operations being performed on a number of memory devices using a DMI-based approach in accordance with some embodiments of the present disclosure. FIGS. 4A-4B illustrate using a DMI signal for performing the selective write in a memory device (in contrast to FIGS. 5A-7B, which do not use a DMI signal). Referring to FIGS. 4A and 4B, the signal diagram 400 includes a data mask inversion (DMI) signal 455 and a DQ signal (“DQ<3:0>) 456 for an 8^{th} memory device (“MD 8”) and a DMI signal 457 and a DQ signal (“DQ<3:0”) 458 for the other memory devices (“Other”) 451. A data mask signal (e.g., a DMI signal) refers to a control signal used in a memory system to manage the flow of data. The DMI signal can be used to indicate whether data being transmitted or received is valid and whether the data should be considered as it is received. The DMI signal can be used in conjunction with data lines to indicate which byte(s) of data are valid during a read or write operation. For example, a DMI signal can be used to specify which bytes in a data burst are to be written or ignored during write operations. A DQ signal refers to a data input/output signal in a memory system. The DQ signal can be used for transmitting data between a memory controller and a memory device. The DQ signals carry data bits being read from or written to the memory device.

As illustrated in FIG. 4A, a writing operation includes three elements including an activate command (“ACT”) 462, a write command (“WR”) 464, and a precharge command (“PRE”) 466. The activate command 462 is used to open a row in a memory array (such as memory array 113 in FIG. 1). When a row is activated, the row is made available for reading or writing operations. Upon receiving the activate command 462, the controller activates a specific row by copying the contents of the row into the sense amplifiers, which are then accessible for read or write operations. The activate command 462 can specify the bank and the row to be activated in the memory array. The write command 464 is used to write data into memory cells of the memory array of the activated row. During a write operation, data is sent to the memory device with the write command 464. The precharge command 466 is used to close a currently active row in a memory array and prepare for subsequent accesses. Precharging disconnects the currently active row from the sense amplifiers, resetting the row and preparing the memory array for either another activation or for refreshing a row. The precharge command 466 can be issued by the controller.

As illustrated in FIG. 4A, the period of time between the activate command 462 and the write command 464 is referred to as the row address to column address delay (or RAS to CAS delay, “tRCD”) 467. Specifically, the tRCD 467 is the time required for the memory to prepare the data in the sense amplifiers after a row has been activated before data can be read or written. The tRCD 467 is measured in clock cycles. The tRCD 467 can be used to determine the overall latency of the memory operations. A lower tRCD value can indicate faster memory performance, as it reduces the waiting time between row activation and data access. The delay between the issuing of the write command 464 and when the data is written into the memory cells of the array is referred to as write latency (“WL”) 468. The WL 468 specifies the time it takes from when a write command is issued until data can be driven onto the data bus by the memory controller. Similar to tRCD, WL 468 is measured in clock cycles. The WL 468 is a factor in determining the responsiveness of write operations in memory. It impacts the overall write throughput and can influence the efficiency of memory bandwidth usage. After a row is activated (with the activate command 462), there is a tRCD delay before a column within that row can be accessed (read or written). If a write operation is issued, the WL then defines the delay before data is written. At the end of a write latency (e.g., WL 468), the data can be written to the memory array.

As illustrated in FIG. 4A, an eighth memory device (e.g., “MD 8”) 451-8 can receive a DMI signal 455 and a DQ signal 456. The DMI signal 455 can indicate to not write data to a particular portion of memory while the DMI signal 455 is high, shown as high DMI signal 461-1. A first portion of a burst length 460-1 corresponds to a high DMI signal 461-1 and, therefore, the corresponding data of the DQ signal 456 is not written to the eighth memory device 451-8. A second portion of the burst length 460-2 corresponds to a low or normal DMI signal and, therefore, the corresponding data of the DQ signal 456 is written to the eighth memory device 451-8. Likewise, the other memory devices 451 receive a respective other DMI signal and a respective other DQ signal. In this example, the DMI signal 457 is low or normal during the write operation and, therefore, the other memory devices 451 are written to as well. This example write operation thus includes a burst length of sixteen (indicated by illustrated burst pulses “0” to “15,” which each contain 4 bits, during the burst lengths 460-1, 460-2, 460-3). At the conclusion of this write operation, the first portion of the eighth memory device 451-8 is unwritten (e.g., the first set of four bytes or first set of 32 bits) while the second portion of the eighth memory device (“MD 8”) 451-8 (e.g., the second set of four bytes or second set of 32 bits) and the other memory devices 451 are written to. The burst pulses are provided in parallel, and accordingly the first “0” burst pulse is transferred for the eighth memory device 451-8 and the other dies 451 at the same time.

As illustrated in FIG. 4B, an eighth memory device (e.g., “MD 8”) 451-8 can receive a DMI signal 455 and a DQ signal 456. The DMI signal 455 can indicate to not write data to a particular portion of memory while the DMI signal 455 is high, shown as high DMI signal 461-2. A second portion of a burst length 463-2 corresponds to a high DMI signal 461-2 and, therefore, the corresponding data of the DQ signal 456 is not written to the eighth memory device 451-8. Likewise, the other memory devices 451 receive a high DMI signal 461-3 (e.g., receive respective high DMI signals) and such other devices are therefore not written to. In contrast, a first portion of the burst length 463-1 corresponds to a low or normal DMI signal and, therefore, the corresponding data of the DQ signal 456 is written to the eighth memory device 451-8. The write operation illustrated in FIG. 4B includes a burst length of sixteen (indicated by illustrated burst pulses “0” to “15” during the burst portions 463-1, 463-2, 463-3). At the conclusion of this write operation, the first portion of the eighth memory device 451-8 is written (e.g., during burst pulses 0 to 7 of burst portion 463-1) while the second portion of the eighth memory device 451-8 (burst pulses 8 to 15 of burst portion 463-2) and the other memory devices 451 are not written to.

FIGS. 5A-7B are associated with a write-based selective write operation. In an example, the write-based approach does not include or use a DMI signal. A number of registers (e.g., mode registers) can be used to indicate whether to use the write-based selective write operation and to indicate particular bytes at which to start and/or end writing, among other parameters of the write-based selective write operation.

FIGS. 5A-5B each illustrate an example mode register for performing a selective write in accordance with some embodiments of the present disclosure. In FIG. 5A, a mode register 500-1 may be a mode register for a memory device such as the memory device 126, 128 of FIG. 1, or the memory device 226, 228 of FIG. 2, among others. The mode register 500-1 can include a number of bit positions 591-7 through 591-0. Bit positions 591-7 (e.g. operational bit 7 or “OP7”) and 591-6 (e.g., “OP6”) can store a selective write status (e.g., “SWS”) value 597. Bit position 591-5 can store a selective write value (e.g., “SELW”) 598. In some examples, the bit positions 591-7 to 591-5 may have previously been reserved for future use (referred to as “RFU”) bits, thereby making it possible to use this approach in prior systems that may not have initially used such selective write bits. The other bit positions 591-4 through 591-0 may represent other functions for other memory operations.

As an example, bit position 591-4 may store a bit used for a memory built-in self-test (MBIST) operation. Bit position 591-3 may store a bit such as an mPPR bit (referred to as a Permanent Partial Page Replacement bit) to mark a memory page or specific section of a memory page as permanently faulty or unusable due to errors that cannot be corrected by standard error correction mechanisms. Bit positions 591-2 and 591-1 may store bits such as sPPR bits (referred to as Soft Partial Page Replacement bits) to mark a memory page or specific section of a memory page as having experienced a transient or correctable error and are typically recoverable or can be corrected by memory error correction mechanisms like ECC (Error-Correcting Code). Bit position 591-0 may store a bit such as an hPPR (referred to as a Hard Partial Page Replacement bit) used to mark pages or section of a page that have encountered hard errors, considered to be permanent and cannot be corrected by standard error-correcting mechanisms such as ECC. Unlike transient errors, which may be recoverable or temporary, hard errors indicate a failure in the memory cell or circuit that is unlikely to be resolved without physical repair or replacement. However, examples are not so limited and the selective write value 598 and selective write status value 597 bits may be stored in a mode register with other bits for other functionalities in the memory.

Table 1 below illustrates an example of the functionality of the selective write status value 597 and selective write value 598 bits.

TABLE 1

| | Register | | | |
|---|---|---|---|---|
| Function | Type | Operand | Data | |
| Selective Write | Write-Only | OP[5] | 0b: | Disable (Default) |
| (“SELW”) | | | 1b: | Enable |
| Selective Write | Read-Only | OP[7:6] | 00b: | Disabled (Default |
| Status | | | 01b: | Enabled on BL range |
| (“SWS”) | | | | (in MR of FIG. 5B) |
| | | | 10b: | Enabled on entire BL |
| | | | 11b: | Reserved |

ter the selective write value (“SELW”) 598 is enabled, a power cycle may be used to reset the status. By default, the selective write status value 597 is not enabled (e.g., is set at “00b”).

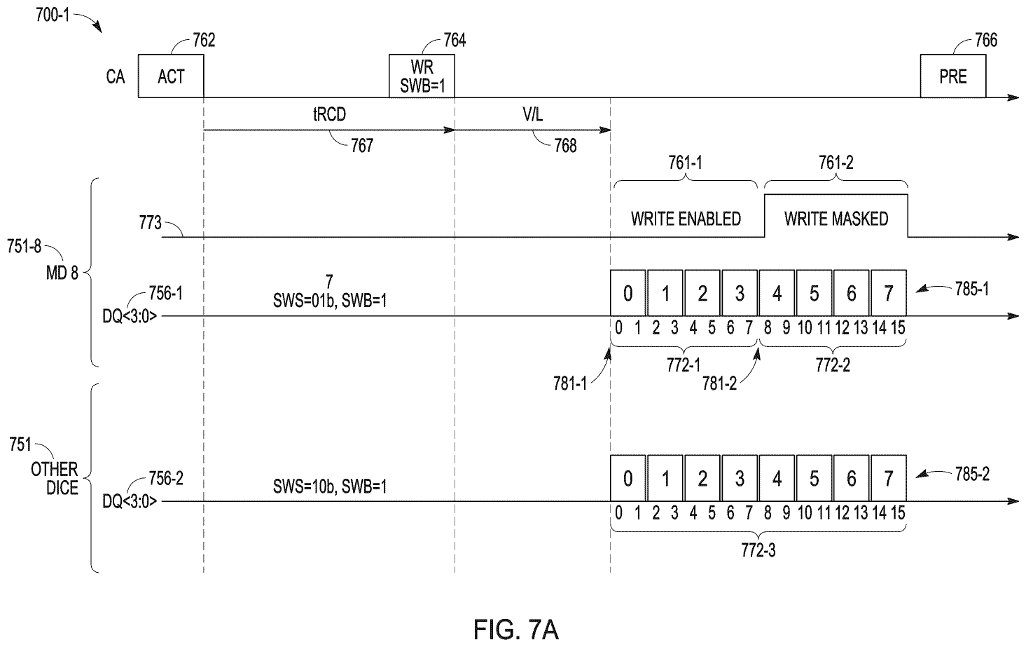

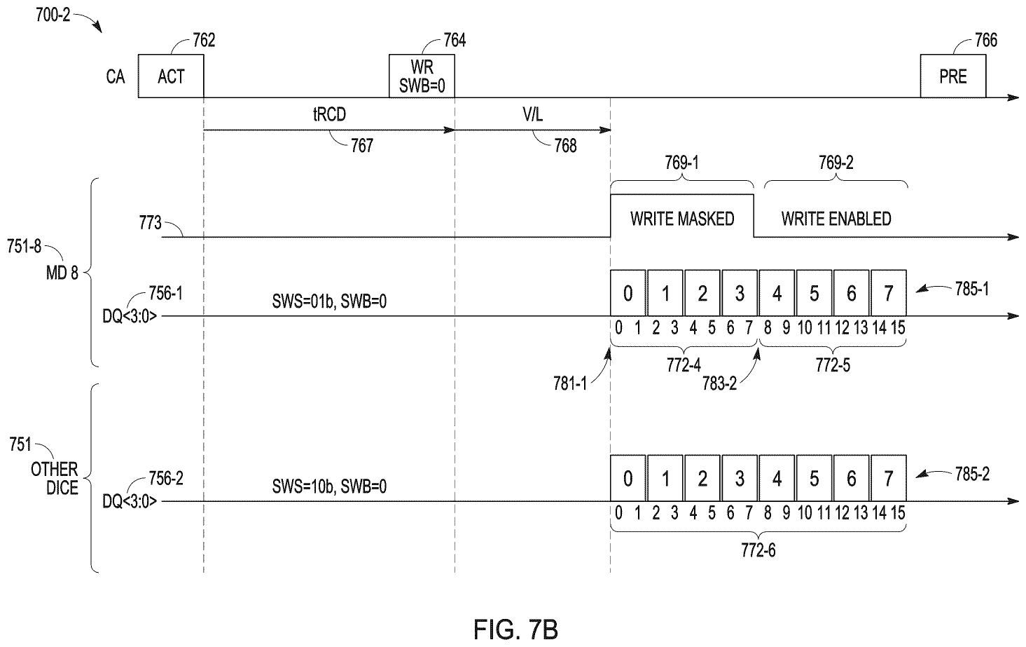

As illustrated in FIG. 5B, a mode register 500-2 may be a mode register of the array 113 in FIG. 1, or the cache 212 in FIG. 2. The mode register 500-2 can include a number of bit positions 593-7 through 593-0. Bit positions 591-7 (e.g. operational bit 7 or “OP7”) through 593-4 (e.g., “OP4”) can indicate an address of an end byte (e.g., “END BYTE”) 599-1. Likewise, bit positions 593-3 (e.g., “OP3”) through 593-0 (e.g., “OP0”) can indicate a start byte (e.g., “START BYTE”) 599-2. For example, the first four bits (OP0 to OP3) in mode register 500-2 can indicate which byte to start writing during a burst length and the last four bits (OP4 to OP7) can indicate which byte to end with during the burst length. An example of this in operation is described in association with FIGS. 7A-7B. In response to the selective write status value (e.g., SWS 597 in FIG. 5A) indicating to enable a burst length (BL) range (e.g., when the SWS value is “01b”), the start byte 599-2 and the end byte 599-1 can be accessed and the subsequent write operation can include writing to the corresponding range of bytes during the burst length, while masking bytes of the burst length not in the range.

Table 2 below illustrates the functionality of the start byte 599-2 and end byte values 599-1.

TABLE 2

| Function | Register Type | Operand | Data |
|---|---|---|---|
| END BYTE | Read/Write | OP[7:4] | 0000b (Default) |
| | | | 0001b . . . 1111b |
| START BYTE | Read/Write | OP[3:0] | 0000b (Default) |
| | | | 00001b . . . 1111b |

After enablement, a power cycle may be used to reset the status. In some examples, when the burst length is equal to 16, OP[7] and OP[3] are ignored. OP[7] and OP[3] are used when the burst length is equal to 32, however.

During a setup for the selective write operation, a particular sequence can be executed to enable the selective write functionality. In an example, the setup process begins with enabling the selective write feature through a mode register (e.g., MR23 using a standard JEDEC protocol with a reserved-for-future-use (RFU) bit). After the initial enablement is set, a multiple-stage key sequence entry process can be completed without interruption. Interruptions of the key sequence from other mode register write/read (MRW/R) commands or non-mode register commands such as activate (ACT), write (WR), or read (RD) commands are not permitted and can invalidate the setup process. During the key sequence, target DQs for a particular memory device or die (e.g., such as an eighth memory device (“MD 8” in the examples described herein)) can be set low while the DQs for other memory devices (e.g., such as memory devices 0, 1, 2, 3, 4, 5, 6, 7, and 9 in the examples described herein) can be set high. The setup process can include both a SELW entry phase and a SELW exit phase, with specific timing requirements between each phase. After the key sequence is successfully completed and the setup exit phase is finished, the selective write operation is enabled on the target memory device. The Selective Write Feature is configured with different operational modes: on the target memory device (e.g., the eighth memory device or MD 8), the feature is enabled with burst length range capability (SWS=“01b”), allowing selective writing to specified portions of the burst length, while on the other memory devices (e.g., devices 0 through 7 and 9), the feature is enabled for entire burst length operations (SWS=“10b”). Following successful enablement, a burst length range (e.g., less than an entire burst length) of data can be written to the target memory device (e.g., the eighth memory device in the examples herein) while the entire burst length of data is written to the other memory devices (e.g., device 0 through 7 and 9 in these examples). A power cycle can be used to reset the selective write status and return to standard operation. Such an example of writing to a burst length range (e.g., burst length 0 to 3 in the eighth memory device) in a particular die and writing to the entire burst length in the other memory devices is further described in association with FIG. 7B below.

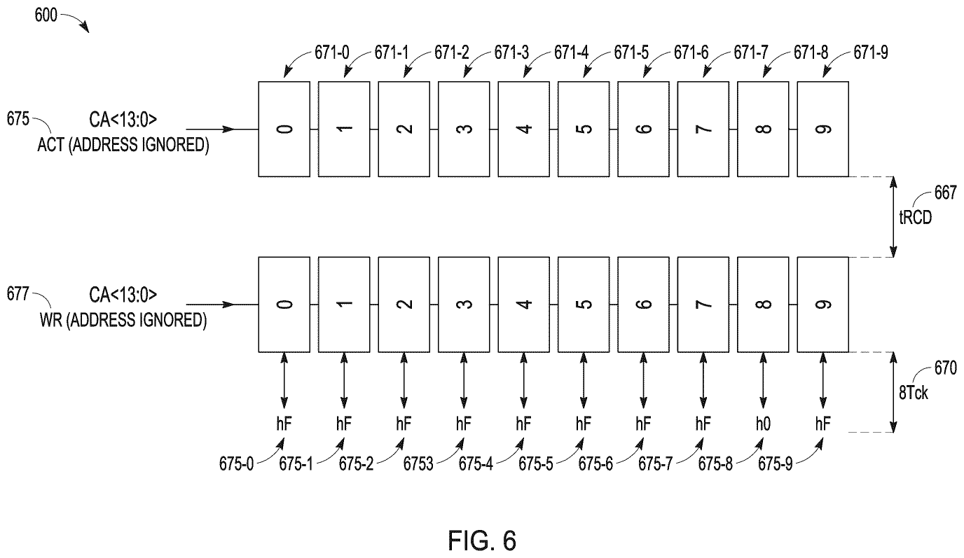

FIG. 6 is an example of a memory system 600 including a number of memory devices and corresponding HIGH or LOW signals associated with performing a selective write operation at different stages in accordance with some embodiments of the present disclosure. The memory system 600 includes a number of memory devices 671-0 to 671-9. At each of an activate stage 675 (e.g., associated with receiving an activate command) and a write stage 677 (e.g., associated with receiving a write command), the memory devices 671-0 to 671-9 receive respective commands using bits of the command/address bus (e.g., CA<13:0>). The tRCD 667 is the time for the memory to prepare the data in the sense amplifiers after a row has been activated before data can be read or written. During performance of write operations during the write stage, the data lines DQ can be driven high or low to affect how a selective write operation is performed. In this example, at the eighth clock cycle (e.g., “8Tck”) 670, the data lines DQ can be driven LOW or HIGH for the eighth memory device. In an example, the data lines DQ<3:0> for the target memory device can be driven to a consistent state—either all HIGH or all LOW—to properly configure the selective write status (SWS) bits in the mode register. Specifically, if the DQ<3:0> data lines are driven LOW during the 8Tck period, then the selective write feature is enabled on the target die, causing MR23 OP[7:6] to be set to “01b” indicating that selective write commands are enabled for a BL range. Conversely, if the DQ<3:0> data lines are driven HIGH during the 8Tck period, then the selective write feature remains disabled, with MR23 OP[7:6] set to “10b” indicating that selective write is enabled for the entire BL.

If a particular data line DQ of a particular die is driven LOW (e.g., “h0”), as is illustrated in FIG. 6 at arrow 675-8, then the selective write mode is enabled on the burst length range indicated for the particular die in a particular mode register (e.g., mode register 500-2 shown in FIG. 5B). In this example, the seventh and sixth bit (e.g., “OP[7:6]”) of a mode register (e.g., mode register 500-1 in FIG. 5A) has a value of “01b” for the eighth memory device, as shown in Table 1 above, indicating enablement of the burst length range. If the data line DQ is driven HIGH (e.g., “hF”), then the selective write mode is enabled for the entire burst length of data. In this example, the memory devices 671-0 through 671-7 and 671-9 have their respective particular data lines driven HIGH (e.g., “hF”), as illustrated in FIG. 6 at arrows 675-0 to 675-7 and 675-9. Therefore, the seventh and sixth bit (e.g., “OP[7:6]”) of a mode register (e.g., mode register 500-1 in FIG. 5A) has a value of “10b” (as shown in Table 1 above) for the 0^{th} through 7^{th} memory device and for the 9^{th} memory device. If all the data bits (e.g., “DQ<3:0>”) on a particular data line DQ are neither all LOW nor all HIGH (e.g., 1010b) for 8tCK, then the selective write mode is not enabled. In some examples, in “×8” and “×16” devices, data bits other than data line DQ bits 3 through 0 are “don't care” bits, meaning that the bits are not used in the determination.

In some embodiments, an additional function bit (e.g., selective write bit “SWB”) is added to the existing JEDEC standard write command to indicate which portions of the burst length of data should be written to specific memory devices. The selective write bit can be mapped to a specific bit (e.g., CA[9]) of the command/address bus when selective write is enabled, allowing the memory controller to specify whether a write operation should be selective or standard. In some examples, the 9^{th} column address pin (“CA9”) can be used to transmit the SWB value. With the SWB=1, the write command is a selective write command and the data can be written from a start byte to an end byte (e.g., start byte 599-2 to end byte 599-1 in FIG. 5B), as indicated in the mode register 500-2 in FIG. 5B for the eighth memory device (e.g., eighth memory device 751-8 (“MD 8”) in FIG. 7A), and with an SWS value of “01b” (enabled on burst length range) as shown in Table 1 above. That is, when SWB=1, the write command is a selective write command, writing data only to the specified portion of the burst length of data on the target memory device. This example is illustrated and described in association with FIG. 7A. With the SWB=0, the write command writes to the complementary portion of the burst length of data on the target device (e.g., eighth memory device 751-8 in FIG. 7B) and the entire burst length on other devices (e.g., memory devices 0 through 7 and 9). In this instance, the eighth memory device (e.g., memory device 751-8 in FIG. 7B) has an SWS=“01b” and the other memory devices (0 through 7 and 9) have an SWS=“10b” (enabled on entire burst length) as shown in Table 1 above.

To illustrate the introduction of the SWB bit, Table 3 describes the values and outcomes.

TABLE 3

| SELW Status | WR Command | |
|---|---|---|
| (SWS) | SWB | Write Operation |
| 01b on MD 8 | 0 | Enabled on complement BL portion |
| | 1 | Enabled on BL portion |
| 10b on remaining | 0 | Internally enabled on entire BL |
| DICE | 1 | Internally disabled |

In a further example of this scenario, the mode register 500-2 (e.g., MR70) can have values OP[3:0]=X000b and OP[7:4]=X011b. If the SWB=1, then only bytes from 0 to 3 on the eighth memory device are written. If the SWB=0, then bytes from 4 to 7 on the eighth memory device (e.g., the complement of OP[3:0]) are written, and the burst length data of the other memory devices (e.g., memory devices 0, 1, 2, 3, 4, 5, 6, 7, and 9) is also written.

FIGS. 7A-7B are each an example of a signal diagram for a number of write operations being performed on a number of memory devices using a write-based approach in accordance with some embodiments of the present disclosure. Referring to FIGS. 7A and 7B, the signal diagram 700-1, 700-2 includes a write signal 773 and a DQ signal (“DQ<3:0>) 756-1 for an 8^{th} memory device (“MD 8”) 751-8 and a DQ signal (“DQ<3:0”) 756-2 for the other memory devices (“Other DICE”) 751. The write signal 773 can be a signal that is internal to the memory device, and its state can depend on SWS and SWB. The write signal 773 can specify which bytes in a data burst are to be written or ignored during write operations. A DQ signal refers to a data input/output signal in a memory system. The DQ signal can be used for transmitting data between a memory controller and a memory device. The DQ signals carry data bits being read from or written to the memory device.

As illustrated in FIG. 7A, a writing operation includes the three elements of an activate command (“ACT”) 762, a write command (“WR”) 764, and a precharge command (“PRE”) 766. The activate command 762 is used to open a row in a memory array (such as memory array 113 in FIG. 1). When a row is activated, the row is made available for reading or writing operations. Upon receiving the activate command 762, the controller activates a specific row by copying the contents of the row into the sense amplifiers, which are then accessible for read or write operations. The activate command 762 can specify the bank and the row to be activated in the memory array. The write command 764 is used to write data into memory cells of the memory array of the activated row. During a write operation, data is sent to the memory device with the write command 764. The precharge command 766 is used to close a currently active row in a memory array and prepare for subsequent accesses. Precharging disconnects the currently active row from the sense amplifiers, resetting the row and preparing the memory array for either another activation or for refreshing the row. The precharge command 766 can be issued by the controller.

As illustrated in FIG. 7A, the period of time between the activate command 762 and the write command 764 is referred to as the row address to column address delay (or RAS to CAS delay, “tRCD”) 767. Specifically, the tRCD 767 is the time required for the memory to prepare the data in the sense amplifiers after a row has been activated before data can be read or written. The tRCD 767 is measured in clock cycles. The tRCD 767 can be used to determine the overall latency of the memory operations. A lower tRCD value can indicate faster memory performance, as it reduces the waiting time between row activation and data access. The delay between the issuing of the write command 464 and when the data is written into the memory cells of the array is referred to as write latency (“WL”) 768. The WL 768 specifies the time it takes from issuance of a write command until data can be driven onto the data bus (e.g., DQ lines) by the memory controller. Similar to tRCD, WL 768 is measured in clock cycles. The WL 768 is a factor in determining the responsiveness of write operations in memory. It impacts the overall write throughput and can influence the efficiency of memory bandwidth usage. After a row is activated (with the activate command 762), there is a tRCD delay before a column within that row can be accessed (read or written). If a write operation is issued, the WL then defines the delay before data is written. At the end of a write latency (e.g., WL 768), the data can be written to the memory array.

As illustrated in FIG. 7A, an eighth memory device (e.g., “MD 8”) 751-8 can receive a write signal 773 (e.g., an internal signal) and a DQ signal 756-1. The write signal 773 can indicate to write data to a particular portion of memory while the write signal 773 is LOW, shown as LOW write signal 761-1. A first portion of a burst length 772-1 corresponds to the LOW write signal 761-1 and, therefore, the corresponding data of the DQ signal 756-1 is written to the eighth memory device 751-8, as the LOW write signal 761-1 indicates to write that portion during the write operation. The example of FIG. 7A does not show a respective internal write signal 773 for each of the other memory dies or devices 751 (e.g., other than the eighth memory device 751-8), however, such write signals can be understood to be high such that writes are disabled for the burst length on such other dies or devices. A second portion of the burst length 772-2 corresponds to a HIGH write signal 761-2 and, therefore, the corresponding data of the DQ signal 756-1 is not written to the eighth memory device 751-8. The bytes of the data for the eighth memory device 751-8 are illustrated by arrow 785-1 and for the other memory devices 751 at arrow 785-2. Each byte (such as byte “0”) corresponds to two beats (e.g., byte “0” corresponds to beats “0” and “1”).

In this example, for the eighth memory device 751-8, the SWS value is “01b” (e.g., “enabled on burst length range,” shown in Table 1) and the SWB value is “1” (from Table 3, indicating “enabled on BL [burst length] portion”), which indicates to enable the selective write for the burst length portion for the eighth memory device 751-8 identified in the mode register 500-2 in FIG. 5B. The start byte, at 781-1, and the end byte, at 783-1, can therefore be written in the eighth memory device 751-8. The SWS value for the other DICE 751 is a value of “10b” (e.g., “enabled on entire BL [burst length]”), and the SWB value is “1” (from Table 3, indicating that the selective write is “Internally disabled”), thereby causing the other DICE 751 to not be written to (e.g., bytes 785-2 are not written during the burst length 772-3).

As illustrated in FIG. 7B, an eighth memory device (e.g., “MD 8”) 751-8 can receive a write signal 773 and a DQ signal 756-1. The write signal 773 can indicate to not write data to a particular portion of memory while the write signal 773 is HIGH, shown as HIGH write signal 769-1. A first portion of a burst length 772-4 corresponds to the HIGH write signal 769-1 and, therefore, the corresponding data of the DQ signal 756-1 is not written to the eighth memory device 751-8, as the HIGH write signal 769-1 indicates to not write that portion during the write operation. The example of FIG. 7B does not show a respective internal write signal 773 for each of the other memory dies or devices 751 (e.g., other than the eighth memory device 751-8), however, such write signals can be understood to be low such that writes are enabled for the burst length on such other dies or devices. A second portion of the burst length 772-5 corresponds to a LOW write signal 769-2 and, therefore, the corresponding data of the DQ signal 756-1 is written to the eighth memory device 751-8. The bytes of the data for the eighth memory device 751-8 are illustrated by arrow 785-1 and for the other memory devices 751 at arrow 785-2.

In this example, the SWS value is “01b” (e.g., “enabled on burst length range,” shown in Table 1) and the SWB value is “0” (from Table 3, indicating “enabled on complement BL [burst length] portion”), which indicates to enable the selective write for the complementary burst length portion on the target device, for example, as identified in the mode register 500-2 in FIG. 5B. The SWS value for the other DICE 751 is a vale of “10b” (e.g., “enabled on entire BL [burst length]”), and the SWB value is “0” (from Table 3, indicating that the selective write is “Internally enabled on entire BL [burst length]”), thereby causing the other DICE 751 to be written to (e.g., bytes 785-2 are written during the burst length 772-6). In this way, the SELW, SWS, and SWB bits described in association with Tables 1, 2, and 3 can be used to properly write and not write particular bytes, regardless of burst length.

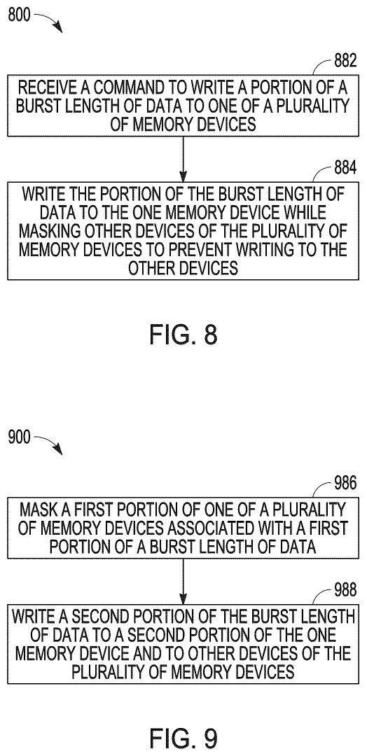

FIG. 8 is an example of a first method 800 corresponding to a method for performing selective writes in a memory device in accordance with some embodiments of the present disclosure. The first method 800 can be performed using the memory device 126, 128 illustrated in FIG. 1. The first method 800 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the first method 800 is performed by the memory controller 100 in coordination with the selective write component 111 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 882, the first method 800 can include receiving a command to write a portion of a burst length of data to one of a plurality of memory devices. The command can be received at a memory controller and sent from a host. At block 884, the first method 800 can include writing the portion of the burst length of data to the one memory device while masking other memory devices of the plurality of memory devices to prevent writing to the other memory devices. In some examples, the memory controller can receive the command using a compute express link (CXL) protocol. The first method 800 can include using a memory controller to provide a first data mask inversion (DMI) signal associated with the one memory device to be at a specified value and provide a second DMI signal associated with the other memory devices at a different specified value while writing the portion of the burst length of data and masking the other memory devices. The first method 800 can include providing the first DMI signal as a logic high signal. The first method 800 can include providing the second DMI signal as a logic low signal.

In some examples, the first method 800 can include accessing data in a first mode register and, based on the data in the first mode register, determining whether to write to each of the plurality of memory devices or write to a portion of the one memory device separate from the other memory devices. In some examples, the method 800 can include, in response to the data in the first mode register indicating to write to the portion of the one memory device separate from the other memory devices, accessing data in a second mode register and, based on the data in the second mode register, determining which portion of the one memory device to write to. The data in the second mode register can include a start byte and an end byte to indicate which bytes to write to the portion of the one memory device.

In some examples, the first method 800 can further include receiving, at the memory controller and from the host, an additional command to write portions of an additional burst length of data to the other memory devices of the plurality of memory devices, and to mask the portion of the one memory device to avoid writing to the portion. The first method 800 can further include writing the portions of the additional burst length of data to the other memory devices while preventing writing to the portion of the one memory device. The first method 800 can include, using the memory controller, providing a data mask inversion (DMI) signal associated with the other memory devices at a specified value while writing the portions of the additional burst length of data.

FIG. 9 is an example of a second method 900 corresponding to a method for performing selective writes in a memory device in accordance with some embodiments of the present disclosure. The second method 900 can be performed using the memory device 126, 128 illustrated in FIG. 1. The second method 900 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the second method 900 is performed by the memory controller 100 in coordination with the selective write component 111 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 986, the second method 900 can include masking a first portion of one of a plurality of memory devices associated with a first portion of a burst length of data. A command can be received at a memory controller and sent from a host that indicates to mask the first portion of the one memory device. In some examples, the burst length can be 16, 8, 4, etc., beats long. At block 988, the second method 900 can include writing the portion of the burst length of data to the one memory device while masking other memory devices of the plurality of memory devices to prevent writing to the other memory devices.

In some examples, the memory controller can receive an additional command to write the first portion of the burst length of data to the first portion of the one memory device. The first portion of the burst length can be written while masking the second portion of the one memory device and the other memory devices of the plurality of memory devices to prevent writing to the second portion and the other memory devices. In some examples, the first portion can be 8 beats of the burst length long and each beat can be equal to 4 bits.

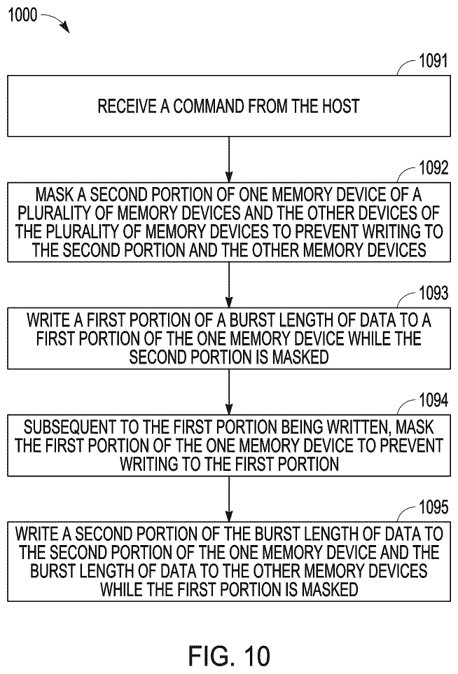

FIG. 10 is an example of a third method 1000 for performing a refresh operation in accordance with a number of embodiments of the present disclosure. The third method 1000 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the third method 1000 is performed by the memory controller 100 in coordination with the selective write component 111 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 1091, the third method 1000 can include receiving a command from a host. At block 1092, the third method 1000 can include masking a second portion of one memory device of a plurality of memory devices and masking other memory devices of the plurality of memory devices to prevent writing to the respective second portion and the other memory devices. At block 1093, the third method 1000 can include writing a first portion of a burst length of data to a first portion of the one memory device while the second portion is masked. In some examples, the first portion of the one memory device is associated with 8 beats of the burst length and the first portion is 4 bytes in length.

At block 1094, the third method 1000 can include, subsequent to the first portion being written, masking the first portion of the one memory device to prevent writing to the first portion. At block 1095, the third method 1000 can include writing a second portion of the burst length of data to the second portion of the one memory device and the burst length of data to the other memory devices while the first portion is masked. In some examples, the third method 1000 can include storing a bit used to indicate whether to write to the first portion and not to the second portion and the other memory devices. In some examples, the plurality of memory devices are written in parallel.

The figures herein follow a numbering convention in which the first digit or digits correspond to the figure number and the remaining digits identify an element or component in the figure. Similar elements or components between different figures may be identified by the use of similar digits. For example, 110 may reference element “10” in FIG. 1, and a similar element may be referenced as 210 in FIG. 2. A group or plurality of similar elements or components may generally be referred to herein with a single element number. For example, a plurality of reference elements 102-1 to 102-N may be referred to generally as 102. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
receiving, at a memory controller and from a host, a command to write a portion of a burst length of data to one of a plurality of memory devices; and
selectively writing the portion of the burst length of data to the one memory device while masking other memory devices of the plurality of memory devices to prevent writing to the other memory devices.

2. The method of claim 1, comprising receiving the command using a compute express link (CXL) protocol.

3. The method of claim 1, comprising, using the memory controller, providing a first data mask inversion (DMI) signal associated with the one memory device at a specified value and providing a second DMI signal associated with the other memory devices at a different specified value while writing the portion of the burst length of data and masking the other memory devices.

4. The method of claim 3, comprising providing the first DMI signal as a logic high signal.

5. The method of claim 4, comprising providing the second DMI signal as a logic low signal.

6. The method of claim 1, comprising accessing data in a first mode register and, based on the data in the first mode register, determining whether to write to each of the plurality of memory devices or write to a portion of the one memory device separate from the other memory devices.

7. The method of claim 6, wherein in response to the data in the first mode register indicating to write to the portion of the one memory device separate from the other memory devices, accessing data in a second mode register and, based on the data in the second mode register, determining which portion of the one memory device to write to.

8. The method of claim 7, wherein the data in the second mode register comprises a start byte and an end byte to indicate which bytes to write to the portion of the one memory device.

9. The method of claim 1, comprising receiving, at the memory controller and from the host, a second command to:
write portions of a second burst length of data to the other memory devices of the plurality of memory devices; and
mask the portion of the one memory device to avoid writing to the portion.

10. The method of claim 9, comprising writing the portions of the second burst length of data to the other memory devices while preventing writing to the portion of the one memory device.

11. The method of claim 10, comprising, using the memory controller, providing a data mask inversion (DMI) signal associated with the other memory devices at a specified value while writing the portions of the second burst length of data.

12. An apparatus, comprising:
a memory controller configured to manage a dynamic random access memory (DRAM) device using a compute express link (CXL) protocol, wherein the memory controller is configured to provide a command to:
mask a first portion of one of a plurality of memory devices associated with a first portion of a burst length of data; and
write a second portion of the burst length of data to a second portion of the one memory device and to other memory devices of the plurality of memory devices.

13. The apparatus of claim 12, wherein the memory controller is configured to receive an additional command to write the first portion of the burst length of data to the first portion of the one memory device while masking the second portion of the one memory device and the other memory devices of the plurality of memory devices to prevent writing to the second portion and the other memory devices.

14. The apparatus of claim 12, wherein the command is received from a host.

15. The apparatus of claim 12, wherein the burst length is 16 beats long.

16. The apparatus of claim 15, wherein the first portion written to is 8 beats of the burst length and each beat is equal to 4 bits.

17. A system, comprising:
a host configured to send a command; and
a memory controller coupled to the host, the memory controller configured to:
receive the command from the host, the command instructing to:
mask a second portion of one memory device of a plurality of memory devices and other memory devices of the plurality of memory devices to prevent writing to the second portion and the other memory devices;
write a first portion of a burst length of data to a first portion of the one memory device while the second portion is masked;
subsequent to the first portion being written, mask the first portion of the one memory device to prevent writing to the first portion; and
write a second portion of the burst length of data to the second portion of the one memory device and the burst length of data to the other memory devices while the first portion is masked.

18. The system of claim 17, wherein the first portion of the one memory device is associated with 8 beats of the burst length and is 4 bytes in length.

19. The system of claim 17, further comprising a memory array configured to store a bit used to indicate whether to write to the first portion and not to the second portion and the other memory devices.

20. The system of claim 17, wherein the plurality of memory devices are written to in parallel.

21. A method, comprising:
receiving, at a memory controller and from a host, a command to perform a selective write operation using a write command-based approach;
configuring a first mode register to enable selective write functionality by setting a selective write enable bit in a first operational bit position;
configuring a second mode register with start byte and end byte values to define a portion of a burst length for selective writing; and
executing a write command with a selective write bit (SWB) to selectively write data to the defined portion of the burst length on a target memory device while masking other portions and other memory devices.

22. The method of claim 21, wherein:
when SWB has a first value, the write command writes data only to the portion of the burst length defined by the start byte and end byte values in the second mode register on the target memory device; and
when SWB has a different second value, the write command writes data to a complementary portion of the burst length on the target memory device and writes an entire burst length to other memory devices.

23. The method of claim 21, wherein configuring the first mode register comprises setting a selective write status (SWS) bit in a second operational bit position to indicate whether selective write is enabled on the target memory device.

24. The method of claim 21, wherein the second mode register comprises:
a start byte field indicating which byte to start writing during the burst length; and
an end byte field indicating which byte to end writing during the burst length.
